(19) United States
(12) Patent Application Publication
(10) Pub. No.: US 2011/0199256 A1
(43) Pub. Date: Aug. 18, 2011

(54) Global Satellite Positioning System Tracking System for Handcuffs and Feetcuffs

(76) Inventor: Charles Chu, Banciao City (TW)

(21) Appl. No.: 12/349,946

(22) Filed: Jan. 7, 2009

(30) Foreign Application Priority Data
Dec. 4, 2008 (TW) 097147055

(51) Int. Cl. G01S 19/42; G01S 19/16

(52) U.S. Cl. 342/357.25; 342/357.54

(57) ABSTRACT

A GPS tracking system for handcuffs and feetcuffs, which includes a sensor, fitted with a GPS tracker, disposed within a mobile restraining device (such as: handcuffs, feetcuffs, police device, and the like). The GPS tracker is provided with a GPS receiving circuit, a microprocessor and a signal transmission circuit, and the sensor detects circumstances regarding the mobile restraining device being illegally opened, which are transmitted to the microprocessor. The GPS receiving circuit is able to receive geographic positioning satellite coordinate signals, after which the geographic positioning satellite coordinate signals are matched with an internal prestored geographic data base to obtain the position of the mobile restraining device, whereupon the position is transmitted to the microprocessor. Accordingly, the microprocessor transmits the position of the mobile restraining device and circumstances regarding being illegally opened to a remote server using the signal transmission circuit, thereby effectively controlling the whereabouts of criminals.

### BACKGROUND OF THE INVENTION

(a) Field of the Invention

The present invention relates to a global satellite positioning system (GPS) tracking system for handcuffs and feetcuffs, and more particularly to a GPS tracking system able to transmit the circumstances regarding a mobile restraining device (such as: handcuffs, feetcuffs, police device, and the like) being illegally opened to a remote server.

(b) Description of the Prior Art

Since development of the global satellite positioning system (GPS) by the American Military, and after the government made the GPS open to public use, there has been continuous advancement in related technology and technical products, including application in various industries and at various levels, greatly increasing the standard of living of people and improving convenience in daily life, even accelerating notification of emergencies and the speed of medical rescue.

The global satellite positioning system consists of several space satellites, ground control stations and GPS receivers. Currently, there are 24 space satellites orbiting the Earth, and each of the space satellites equally maintain transmission of geographic position satellite coordinate signals carrying satellite orbit data and time for every type of terrestrial GPS receiver to receive. The ground control stations are responsible for tracing and controlling operation of each of the space satellites, as well as being responsible for correcting and maintaining each of the space satellites, thereby enabling normal continual transmission of each type of parameter data to the GPS receivers.

However, satellite navigators of the prior art are only able to indicate current position, route direction and neighboring buildings, and are not used in controlling the whereabouts of criminals, resulting in the inability to track movement of criminals, and thus limiting use range thereof. Hence, there is still a need for developmental design of other uses for satellite navigators.

### SUMMARY OF THE INVENTION

Hence, in light of the shortcomings of the aforementioned prior art, the inventor of the present invention, having accumulated knowhow and manufacturing experience of a diverse range of GPS (Global Satellite Positioning System) products, attentively researched various methods to resolve the shortcomings, which, following continuous research and improvements, culminated in the design of a completely new GPS tracking system for handcuffs and feetcuffs of the present invention.

The objective of the present invention is to provide the GPS tracking system for handcuffs and feetcuffs with the facility to transmit the circumstances regarding a mobile restraining device being illegally opened to a remote server, thereby effectively controlling the whereabouts of criminals.

According to the aforementioned objective, the GPS tracking system for handcuffs and feetcuffs of the present invention comprises a sensor disposed within a mobile restraining device (such as: handcuffs, feetcuffs, police device, and the like). The sensor is fitted with a GPS tracker, and the GPS tracker is provided with a GPS receiving circuit, a microprocessor and a signal transmission circuit, wherein the sensor is able to detect circumstances regarding the mobile restraining device being illegally opened, and the detected information is transmitted to the microprocessor of the GPS tracker. The GPS receiving circuit of the GPS tracker is able to receive geographic positioning satellite coordinate signals, after which the geographic positioning satellite coordinate signals are matched with an internal prestored geographic data base to obtain the position and time of the mobile restraining device, whereupon the position and time is transmitted to the microprocessor. When in use, the microprocessor obtains the position and time of the mobile restraining device from the GPS receiving circuit, and obtains the circumstances regarding the mobile restraining device being illegally opened from the sensor, whereupon the signal transmission circuit transmits the information obtained to a remote server. Accordingly, the remote server is then able to immediately notify the relevant authorities of the information, thereby effectively controlling the whereabouts of criminals.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an external elevational view of a GPS tracking system for handcuffs and feetcuffs of the present invention.

FIG. 2 is a circuit block diagram of the GPS tracking system for handcuffs and feetcuffs of the present invention.

### DETAILED DESCRIPTION OF THE PREFERRED EMBODIMENTS

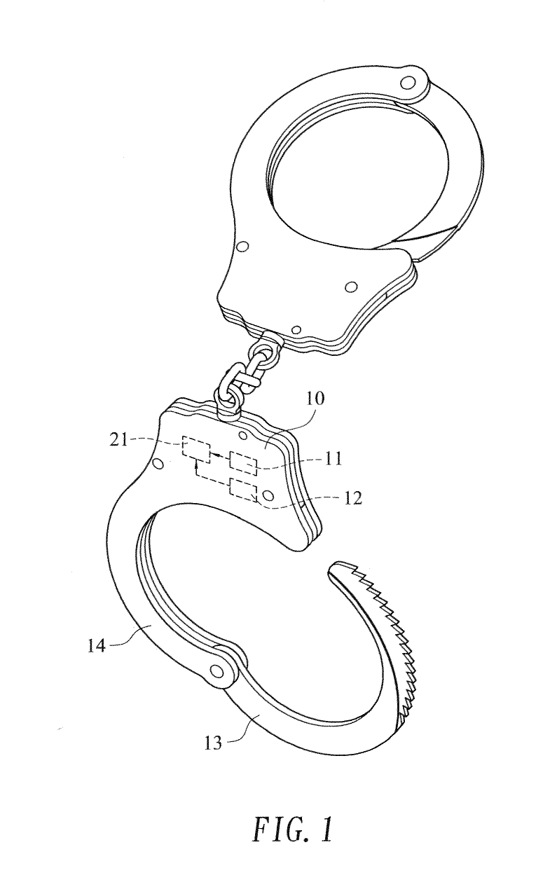

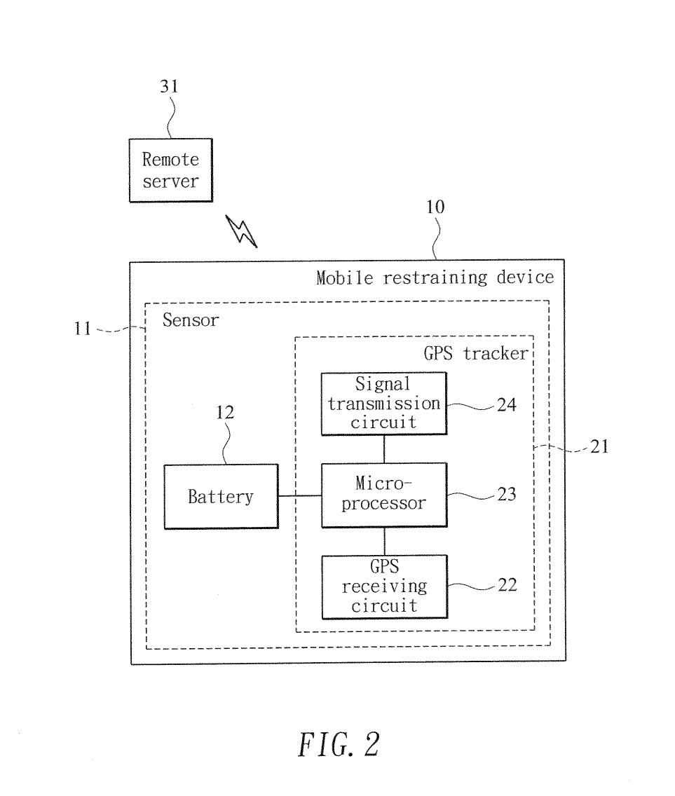

The present invention relates to a GPS tracking system for handcuffs feetcuffs. Referring to FIGS. 1 and 2, which show a GPS tracking system for handcuffs and feetcuffs of the present invention, wherein a sensor 11 is disposed within a mobile restraining device 10 (such as: handcuffs, feetcuffs, police device, and the like), and the sensor 11 is fitted with a GPS (Global Satellite Positioning System) tracker 21. The GPS tracker 21 is provided with a GPS receiving circuit 22, a microprocessor 23 and a signal transmission circuit 24, wherein the sensor 11 and the GPS tracker 21 are connected together, and the sensor 11 is able to detect the circumstances regarding the mobile restraining device 10 being illegally opened (such as: using wire to open, cutting, sawing, striking with an external force, damaging with an external force, and so on), and the detected information is transmitted to the microprocessor 23 of the GPS tracker 21.

The microprocessor 23 of the GPS tracker 21 is separately connected to the GPS receiving circuit 22 and the signal transmission circuit 24, and the GPS receiving circuit 22 of the GPS tracker 21 is able to receive geographic positioning satellite coordinate signals, after which the geographic positioning satellite coordinate signals are matched with an internal prestored geographic data base to obtain the position and time of the mobile restraining device 10, whereupon the position and time are transmitted to the microprocessor 23.

According to the assembly of the aforementioned components, when in use, the microprocessor 23 obtains the position and time of the mobile restraining device 10 from the GPS receiving circuit 22, and obtains information on the circumstances regarding the mobile restraining device 10 being illegally opened from the sensor 11, whereupon the information is transmitted to a remote server 31 through the signal transmission circuit 24. Accordingly, the remote server 31 is able to immediately notify the relevant authorities of the information, thereby effectively controlling the whereabouts of criminals.

Referring again to FIGS. 1 and 2, the sensor 11 is also able to detect the circumstances regarding the mobile restraining device 10 not being illegally opened, and such circumstances are transmitted to the microprocessor of the GPS tracker 21, thereby enabling the microprocessor 23 to transmit the position and time of the mobile restraining device 10, as well as information on the aforementioned circumstances to the remote server 31.

Referring again to FIGS. 1 and 2, the microprocessor 23 can be set with a criminal GEOFENCE (geographic alert) range (that is, a territorial range can be set that permits a criminal to move about in), and when the microprocessor 23 has been set with the GEOFENCE range, then the position of the mobile restraining device 10 is obtained from the GPS receiving circuit 22, and it can be determined whether or not the position is within the range. If it is determined that the position has gone beyond the range, then the information regarding going beyond the range is transmitted to the remote server 31 through the signal transmission circuit 24, thereby enabling the remote server 31 to immediately notify the relevant authorities of the information, and thus effectively controlling the whereabouts of the criminal.

Referring again to FIGS. 1 and 2, the signal transmission circuit 24 can be connected to the remote server 31 through wired means, thereby enabling the microprocessor 23 to transmit information regarding the circumstances of the mobile restraining device 10 being illegally opened and going beyond the permitted range of movement of the mobile restraining device 10 to the remote server 31 through wired transmission means.

Referring again to FIGS. 1 and 2, the signal transmission circuit 24 can be connected to the remote server 31 through wireless means, thereby enabling the microprocessor 23 to transmit information regarding the circumstances of the mobile restraining device 10 being illegally opened and going beyond the permitted range of movement of the mobile restraining device 10 to the remote server 31 through wireless transmission means (such as: using RF (radio frequency) signals).

Referring again to FIGS. 1 and 2, a battery 12 is located within the mobile restraining device 10, the battery 12 being connected to the sensor 11, thereby enabling electric power to be supplied to the sensor 11 and the GPS tracker 21.

Referring again to FIGS. 1 and 2, the battery 2 can be a rechargeable battery (such as: a high performance Lipoly (Lithium Polymer) rechargeable battery), which has a flexible external form and is convenient to recharge, moreover, the battery 12 can be connected to a solar panel (not shown in the drawings) located on the mobile restraining device 10, thereby enabling electric power converted from solar energy received by the solar panel to charge the battery 12, thus enabling the battery 12 to maintain a fully charged state; or a battery charger can be used to charge the battery 12 and enable the battery 12 to maintain a fully charged state. Accordingly, electric power can be supplied to the sensor 11 and the GPS tracker 21 for long periods of time.

Referring again to FIGS. 1 and 2, a switch (not shown in the drawings) is fitted to a movable arcuate clasp 13 of the mobile restraining device 10, and one end of the switch is connected to the sensor 11, while another end is connected to the battery 12. When using the mobile restraining device 10, and the movable arcuate clasp 13 is clasped into a fixed arcuate clasp 14, then the switch is caused to be in a current conducting (ON) state, thereby causing the battery 12 to supply power to the sensor 11 and the GPS tracker 21. When the mobile restraining device 10 is not being used, and the movable arcuate clasp 13 has been opened, then the switch is caused to be in a power-off (OFF) state, thereby causing the battery 12 to stop supplying power to the sensor 11 and the GPS tracker 21. Accordingly, when not in use, the switch is closed, thereby achieving a power saving function.

Referring again to FIGS. 1 and 2, the GPS receiving circuit 22 can use GPS, A-GPS (Assisted Global Satellite Positioning System) or GPSone (GPS One, Global Satellite Positioning System One) satellite positioning technology, and the GPS information, including a combination of circumstances related to the mobile restraining device 10, such as time, position, altitude and speed, are transmitted to the remote server 31.

Referring again to FIGS. 1 and 2, communication media of the signal transmission circuit 24 includes various kinds of wireless communication, such as: RF, GSM (Global System for Mobile Communications), GPRS (General Packet radio Services), CDMA (Code Division Multiple Access), WiMAX (Worldwide Interoperability for Microwave Access), WiFi (Wireless Fidelity) or satellite to satellite communication.

Referring again to FIGS. 1 and 2, when the GPS signal is weak, then the microprocessor 23 can control the signal receiving circuit 24 to replace the GPS positioning signal with a GSM or CDMA base station positioning signal LBS (Location Based Service)/GPSone (GPS One), or a function that automatically records the last time and position is used to record the position of the mobile restraining device 10.

Referring again to FIGS. 1 and 2, the microprocessor 23 can be set for timing transmission of the geographical position of the mobile restraining device 10, thereby enabling the microprocessor 23 to obtain the position of the mobile restraining device 10 from the GPS receiving circuit 22 at set intervals and continuously transmit the position to the remote server 31 for relevant personnel to query the current position of the mobile restraining device 10 from the remote server 31.

Referring again to FIGS. 1 and 2, the sensor 11 is able to use an angle sensor to select entering a sleep mode according to the use situation, thereby achieving a power saving objective.

Referring again to FIGS. 1 and 2, when the power of the battery 12 is insufficient, the microprocessor 23 is able to transmit a low power message to the remote server 31 for relevant personnel to process.

Referring again to FIGS. 1 and 2, the GPS tracker 21 is movably located on the sensor 11, thereby enabling the GPS tracker 21 and the sensor 11 to be separated or joined together for use thereof, that is, if there is an issue of large distances, then the sensor 11 and the GPS tracker 21 can be joined together and installed in the mobile restraining device 10 (such as: handcuffs, feetcuffs, police device, and the like) for single use thereof, and information transmitted directly to the remote server 31.

However, if the distances are close, then the GPS tracker 21 and the sensor 11 can be separated for use thereof, and several sensors 11 need only be installed in the mobile restraining device 10 (such as: handcuffs, feetcuffs, police device, and the like), thereby conveniencing the criminal to move about, and the GPS tracker 21 can be installed nearby (such as: in a nearby vehicle, in a nearby police vehicle, in a nearby building, on the person of nearby control personnel, on a nearby personal GPS tracking system, and so on), thereby enabling the sensors 11 to transmit the detected information to the GPS tracker 21 through wireless or wired means, whereupon the GPS tracker 21 transmits the collected data to the remote server 31.

When used separately, the sensors 11 transmit the detected information to the GPS tracker 21 through wireless radio frequency (RF) transmission means (such as: radio frequency (RF) Bluetooth transmission means), whereupon the GPS tracker 21 transmits the collected data to the remote server 31. Moreover, the sensor 11 can also be set with a radio frequency (RF) GEOFENCE range, whereby when the mobile restraining device 10 (such as: handcuffs, feetcuffs, police device, and the like) goes beyond the set geographic area (RF range), thus causing the GPS tracker 21 to be unable to receive information from the sensor 11, then the GPS tracker 21 transmits information regarding going beyond the RF range to the remote server 31 through the signal transmission circuit 24, whereupon the remote server 31 immediately notifies relevant authorities of the information, thereby effectively controlling the whereabouts of criminals.

In conclusion, the GPS tracking system for handcuffs and feetcuffs of the present invention is assuredly provided with an innovative structure not found in the prior art. Moreover, no similar products have been seen in any publication or in the market; the present invention is thus provided with undoubted originality. In addition, the present invention is provided with unique characteristics and functionality that are without comparison in the prior art. Hence, the incomparable advancement of the present invention clearly complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A GPS (Global Satellite Positioning System) tracking system for handcuffs and feetcuffs, comprising:
a mobile restraining device, a sensor is disposed within the mobile restraining device, and the sensor is able to detect the circumstances regarding the mobile restraining device being illegally opened, and the detected information is transmitted to a microprocessor of a GPS tracker;
the GPS tracker, the GPS tracker is fitted to and connected to the sensor, the GPS tracker is provided with a GPS receiving circuit, the microprocessor and a signal transmission circuit, and the microprocessor is separately connected to the GPS receiving circuit and the signal transmission circuit; the GPS receiving circuit is able to receive geographic positioning satellite coordinate signals, and then the geographic positioning satellite coordinate signals are matched with an internal prestored geographic data base to obtain the position of the mobile restraining device, whereupon the position is transmitted to the microprocessor;
whereby the microprocessor obtains the position of the mobile restraining device from the GPS receiving circuit, and obtains the circumstances regarding the mobile restraining device being illegally opened from the sensor, whereupon the signal transmission circuit transmits the information obtained to a remote server, thereby effectively controlling the whereabouts of criminals.

2. The GPS tracking system for handcuffs and feetcuffs according to claim 1, wherein the microprocessor is set with a territorial range of permitted movement for a criminal (GEOFENCE (geographic alert) range), when the microprocessor has been set with the GEOFENCE range, then the position of the mobile restraining device is obtained from the GPS receiving circuit, from which is determined whether or not the position is within the set range; if it is determined that the position has gone beyond the range, then the information regarding going beyond the range is transmitted to the remote server through the signal transmission circuit, thereby enabling the remote server to immediately notify the relevant authorities of the information, and thus effectively controlling the whereabouts of the criminal.

3. The GPS tracking system for handcuffs and feetcuffs according to claim 2, wherein the signal transmission circuit is connected to the remote server through wired means, thereby enabling the microprocessor to transmit the circumstances regarding the mobile restraining device being illegally opened and going beyond the range of permitted movement to the remote server through wired transmission means.

4. The GPS tracking system for handcuffs and feetcuffs according to claim 2, wherein the signal transmission circuit is connected to the remote server through wireless means, thereby enabling the microprocessor to transmit the circumstances regarding the mobile restraining device being illegally opened and going beyond the range of permitted movement to the remote server through wireless transmission means.

5. The GPS tracking system for handcuffs and feetcuffs according to claim 1, wherein a battery is located within the mobile restraining device, and the battery is connected to the sensor, thereby enabling electric power to be supplied to the sensor and the GPS tracker.

6. The GPS tracking system for handcuffs and feetcuffs according to claim 5, wherein the battery is a rechargeable battery, which is connected to a solar panel located on the mobile restraining device, thereby enabling electric power converted from solar energy received by the solar panel to charge the battery, thus enabling the battery to maintain a fully charged state.

7. The GPS tracking system for handcuffs and feetcuffs according to claim 1, wherein the GPS receiving circuit uses GPS, A-GPS (Assisted Global Satellite Positioning System) or GPSone (GPS One, Global Satellite Positioning System One) satellite positioning technology, and the GPS information related to the mobile restraining device, including a combination of time, position, altitude and speed, are transmitted to the remote server.

8. The GPS tracking system for handcuffs and feetcuffs according to claim 1, wherein communication media of the signal transmission circuit includes various kinds of wireless communication, including: RF (Radio Frequency), GSM (Global System for Mobile Communications), GPRS (General Packet radio Services), CDMA (Code Division Multiple Access), WiMAX (Worldwide Interoperability for Microwave Access), WiFi (Wireless Fidelity) or satellite to satellite communication.

9. The GPS tracking system for handcuffs and feetcuffs according to claim 1, wherein when the GPS signal is weak, then the microprocessor controls the signal receiving circuit to replace the GPS positioning signal with a GSM or CDMA base station positioning signal LBS (Location Based Service) or GPSone (GPS One).
